(19) United States
(12) Patent Application Publication
(10) Pub. No.: US 2002/0110232 A1
(43) Pub. Date: Aug. 15, 2002

(54) Systems, methods, and devices for enhancing communications

(75) Inventor: Theodore E. Casellini, Cambria, CA (US)

Correspondence Address: SCHWEGMAN, LUNDBERG, WOESSNER & KLUTH, P.A., P.O. BOX 2938, MINNEAPOLIS, MN, 55402, US

(73) Assignee: ADC Telecommunications, Inc.

(21) Appl. No.: 09/780,082

(22) Filed: Feb. 9, 2001

(51) Int. Cl. H04M 3/42

(52) U.S. Cl. 379/210.01

(57) ABSTRACT

Systems, methods, and devices are discussed that enhance communications. One aspect of the invention includes a method for enhancing communications between individuals. The method includes setting a call placement via a piece of software that manages voice data, calling a target phone number to reach a target, calling a callback phone number to reach the subscriber, and connecting a subscriber to the target. The act of connecting connects the subscriber to the target when the target phone number is answered by the target after which the subscriber answers the callback phone number. The act of connecting connects the target to the subscriber via a connection that bypasses a local exchange carrier.

### TECHNICAL FIELD

The technical field relates generally to messaging in communications networks. More particularly, it pertains to connecting an individual to a caller when both the individual and the caller are available such that the caller may communicate directly with the individual without having to leave a message for the individual.

### COPYRIGHT NOTICE—PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent files or records, but otherwise reserves all copyright rights whatsoever. The following notice applies to the software and data as described below and in the drawings attached hereto: Copyright©2000, ADC Telecommunications, Inc., All Rights Reserved.

### BACKGROUND

Like a note left on a door, a desk, or a chair, a message is a means for one person to communicate with another who is unavailable. Messaging services, such as voice mail, have become popular because people who need to be reached are often away from their offices, homes, or are at diverse locations and times. Messaging services have improved communications by allowing messages to be sent at the convenience of the sender and to be accessed at the convenience of the receiver.

Although messaging services have improved communications, much frustration remains. Consider the plight of a caller who calls an individual. Suppose the individual is unavailable at the phone number called by the caller, so the voice mail of the individual answers the caller. The caller leaves a message for the individual to call him back. The individual may have the same difficulty of making a connection with the caller if the caller is also unavailable.

The above is an example of phone tag. Phone tag frustrates the communication experience of individuals because it thwarts the desire to have a real-time conversation between individuals. Thus, what is needed are systems, methods, and devices for enhancing communications between individuals.

### SUMMARY

Systems, methods, and devices for enhancing communications are discussed. An illustrative aspect includes a method for enhancing communication between individuals. The method includes setting a call placement via a piece of software that manages voice data, calling a target phone number to reach a target, calling a callback phone number to reach the subscriber, and connecting a subscriber to the target. The act of connecting connects the subscriber to the target when the target phone number is answered by the target after which the subscriber answers the callback phone number. The act of connecting connects the target to the subscriber via a connection that bypasses a local exchange carrier.

Another illustrative aspect includes a computer-readable medium having instructions stored thereon for enhancing communications. The computer-readable medium includes a method that includes setting a call placement via a piece of software that manages voice data, calling a target phone number to reach a target, calling a callback phone number to reach the subscriber, and connecting a subscriber to the target. The act of connecting connects the subscriber to the target when the target phone number is answered by the target after which the subscriber answers the callback phone number. The act of connecting connects the target to the subscriber via a connection that bypasses a local exchange carrier.

Another illustrative aspect includes a platform for enhancing communications. The platform includes a subscriber who subscribes to the communication services of the platform, a target that the subscriber desires to communicate with, and an engine that executes a call placement that is set up by the subscriber. The engine connects the subscriber to the target if the target answers a target phone number and the subscriber answers the callback phone number. The connection between the subscriber and the target bypasses a local exchange carrier.

Another illustrative aspect includes a system for enhancing communications. The system includes multiple servers; each server of the multiple servers is located in a geographic area to define a node. The system also includes a network coupling the multiple servers and at least one piece of software in one of the multiple servers. The piece of software executes a call placement that is placed by a subscriber so that the subscriber can be connected to a target if the target answers a target phone number and the subscriber answers a callback phone number. The connection between the subscriber and the target automatically occurs so as to eliminate the need for a human operator.

### BRIEF DESCRIPTION OF THE DRAWINGS

FIG. 1 is a diagram of a system for enhancing communications according to one aspect of the present invention.

FIG. 2 is a diagram of a platform for enhancing communications according to one aspect of the present invention.

FIG. 3 is a process diagram of a method for enhancing communications according to one aspect of the present invention.

### DETAILED DESCRIPTION

In the following detailed description of exemplary embodiments of the invention, reference is made to the accompanying drawings which form a part hereof, and in which is shown, by way of illustration, specific exemplary embodiments in which the invention may be practiced. In the drawings, like numerals describe substantially similar components throughout the several views. These embodiments are described in sufficient detail to enable those skilled in the art to practice the invention. Other embodiments may be utilized and structural, logical, electrical, and other changes may be made without departing from the spirit or scope of the present invention. The following detailed description is, therefore, not to be taken in a limiting sense, and the scope of the present invention is defined only by the appended claims.

The embodiments of the invention focus on enhancing communications among people. For the sake of clarity, the discussion will refer to two hypothetical individuals: one is called a target and the other a subscriber. A target is one with whom the subscriber wishes to communicate by using a communication device, such as a telephone. The subscriber is so named because he subscribes to a suite of communication services offered by the various embodiments of the invention. This suite of communication services helps the subscriber to manage information, such as a message, or to communicate, such as a call.

As discussed in the background, the seesawing effort of placing messages between individuals frustrates a communication experience. The embodiments of the invention solve this by connecting the target to the subscriber when the target and the subscriber are available so that the target may have a real-time conversation with the subscriber. The embodiments of the invention solve this and other problems as discussed in full below.

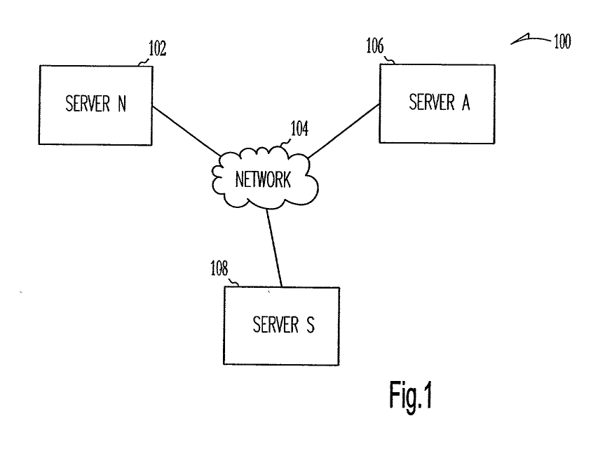

FIG. 1 is a block diagram of a system 100 for enhancing communications according to one aspect of the present invention. The system 100 includes a number of servers, such as server N 102, server S 108, and server A 106, which are coupled together by a network 104. The network 104 includes an asynchronous transfer mode (ATM) network and a satellite network. These servers include hardware and software that provide broadband services, such as voice mail, to a network.

Each of these servers is located in a particular geographic region. Each server has a one-to-many relationship with area codes. Recall that the term “area code” means a multiple-digit number that identifies a telephone service area of a country, such as the United States. For the area codes that the server has a relationship with, each server defines a node for these area codes. The node represents a local point of presence (LPOP) with respect to the area codes that have a relationship with the server. A telephone call that is made with respect to the LPOP is a local call.

Consider the following example that is presented for illustrative purposes only: Suppose that a subscriber is located in a geographic region, such as New York, which includes the server N 102. The subscriber wishes to communicate with a target located in a geographic region, such as Atlanta, which includes the server A 106. The subscriber logs into his broadband services that are served by server N 102 although his subscription account may be served by any server, such as the server S 108, which is located in San Jose. Then, the subscriber sets up a call placement using the broadband services at the server S 108.

The call placement calls the target using the LPOP of the target, such as the server A 106. When the target answers the call, the call placement requests that the target remain on the line while the call placement calls the subscriber. The call placement calls the subscriber using the LPOP of the callback phone number, which is used to call the subscriber. When the subscriber answers the call, the call placement connects the target to the subscriber so that the target may have a real-time conversation with the subscriber.

A company typically uses a Private Branch Exchange (PBX) to allow users to place calls to each other without going through a public telephone network. Various useful features are available to users within a PBX. One particular feature, called camp-on, has existed since the early 1970s.

This feature allows a first user to dial the extension of a second user using a plain old telephone. If there is no answer or the extension is busy, the first user uses flash-hook. He then dials an access code to “camp on” his extension. When the extension of the second user frees up, the extension of the second user rings. If the extension of the second user is answered, the extension of the first user rings. When the extension of the first user is answered, then the party at the extension of the second user is connected to the party at the extension of the first user.

One issue with this feature is that it is limited to a PBX. In contrast, the embodiments of the present invention can be used flexibly in a global network, such as an ATM network or a satellite network.

Returning to FIG. 1, at least one piece of software exists in one of the servers, such as server N 102, server S 108, and server A 106. This piece of software executes a call placement that is placed by a subscriber. When the call placement is executed, the subscriber can be connected to a target if the target answers a target phone number, and subsequently, the subscriber answers a callback phone number. This connection occurs automatically so as to eliminate the need for a human operator.

When the system 100 calls the target phone number, it chooses a node that is local to the target phone number. When the system 100 calls the callback phone number, it chooses a node that is local to the callback phone number. In one embodiment, the selection of the node is based on the area code of the phone number, be it the target phone number or the callback phone number. Such selection of nodes allows the connection between the target and the subscriber to bypass local exchange carriers.

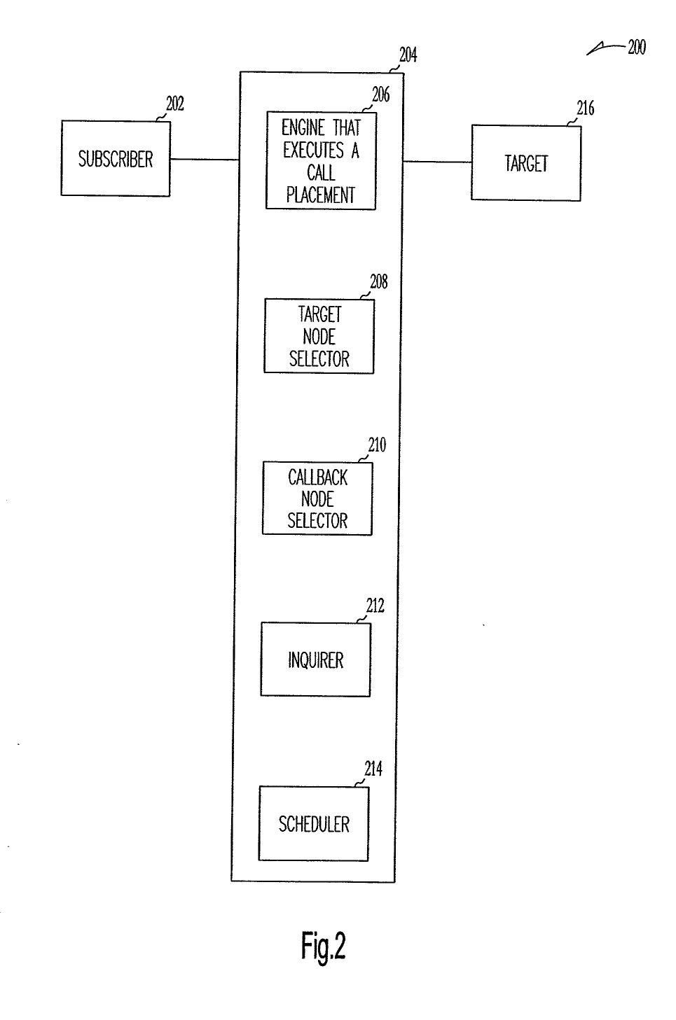

FIG. 2 is a diagram of a platform 200 for enhancing communications according to one aspect of the present invention.

The platform 200 manages communication services, such as voice mail, for the subscriber. The platform 200 includes a suite of communication services that are subscribed to by the subscriber. The platform 200 supports both wireless and wired communications.

The platform 200 includes both hardware and software. The hardware aspect leverages economical and powerful microprocessors available from vendors, such as Intel Corporation. The hardware aspect includes network interfaces that support carriers, such as T1 and E1, and protocols, such as Signaling System 7 (SS7) and R2. The hardware aspect includes digital signal processing (DSP) to provide a desired quality of speech in the signals and speech recognition processing to support hands-free communication services, such as voice mail.

The software aspect includes a modern and powerful operating system, which operates in real time. Applications reside on the operating system. These applications, alone and in combination, provide the communication services subscribed to by the subscriber.

The platform 200 includes a software aspect 204. The software aspect 204 includes a software representation of a subscriber, which is referred to as subscriber 202. Any suitable software representation of the subscriber may be used. One suitable software representation includes the use of an object in an object-oriented programming environment. One with ordinary skill in the art understands that an object includes a variable comprising both routines and data that is treated as a discrete entity. When a human subscriber interacts with the software aspect 204, the software aspect 204 creates the subscriber 202 to represent the human subscriber.

The software aspect 204 represents a human target as a target 216 using a suitable software representation, such as an object. The target 216 is the desired target that the subscriber wishes to communicate with using the communication services of the software aspect 204.

The software aspect 204 includes an engine 206. The engine 206 executes a call placement that is set up by the subscriber. The call placement connects the subscriber to the target if the target answers a target phone number, and subsequently, the subscriber answers the callback phone number. The connection is made such that it bypasses a local exchange carrier.

The software aspect 204 includes a target node selector 208 and a callback node selector 210. These node selectors select a node from which a phone number is called, such as a target phone number or a callback phone number. In one embodiment, these node selectors select the node based on the area code of the phone number.

The software aspect 204 includes an inquirer 212 that inquires of the identity of the party answering a phone number. The inquirer 212 determines if the party answering the target phone number is the target. The inquirer 212 also determines whether the party answering the callback phone number is the subscriber.

In one embodiment, the inquirer 212 may present the party answering the phone number with options that can be selected using the keypad of the telephone. These options will allow the party answering the phone number to identify whether they are the target or the subscriber. If the party is not the target or the subscriber, the software aspect 204 executes the scheduler 214.

The scheduler 214 reschedules the calling of either the target or the subscriber in one of two conditions. One of the two conditions includes that the party answering the callback phone number is not the subscriber, or in the case of the target, the party answering the target phone number is not the target. The other of the two conditions includes that the callback phone number is unanswered, or in the case of the target, the target phone number is unanswered.

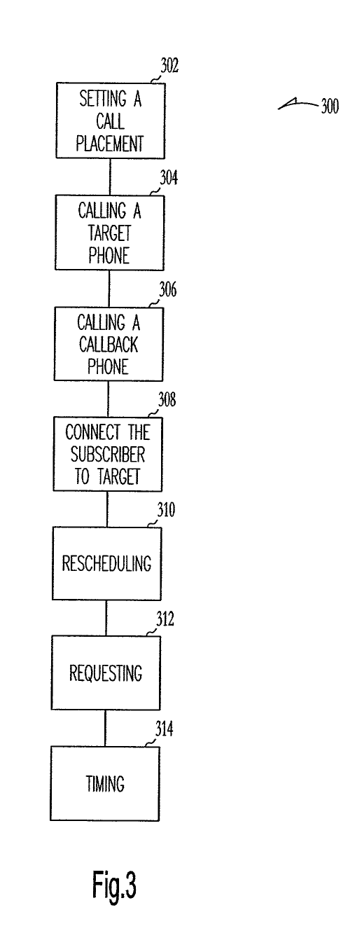

FIG. 3 is a process diagram of a method for enhancing communications between individuals according to one aspect of the present invention. The process 300 is a method for enhancing communications.

The process 300 includes an act 302 for setting up a call placement via a piece of software that manages voice data. The act 302 for setting up includes entering the target number of the target into the piece of software, entering the callback number of a subscriber into the piece of software, and entering the time interval by which the act of rescheduling is to occur. The act of entering the time interval need not be made since the process 300 automatically provides a default time interval if none is entered.

The process 300 includes an act 304 for calling a target phone number to reach a target. The act 304 for calling the target phone number selectively calls from a node that is local to the target phone number. If the target phone number is unanswered or answered by a party who is not the target, the process 300 executes the act 310 for rescheduling.

The process 300 includes an act 306 for calling a callback phone number to reach a subscriber. The act 306 for calling the callback phone number selectively calls from a node that is local to the callback phone number. If the callback phone number is unanswered or answered by a party who is not the subscriber, the process 300 executes the act 310 for rescheduling.

The process 300 includes an act 308 for connecting the subscriber to the target. The act 308 is executed if the target phone number is answered by the target and the callback phone number is answered by the subscriber. The act 308 connects the target to the subscriber via a connection that bypasses a local exchange carrier.

The process 300 includes an act 310 for rescheduling the acts of calling, such as acts 304 and 306. The act 310 reschedules in one of two conditions. One of the two conditions includes that the phone number is busy. The other of the two conditions includes that the phone number is unanswered.

The process 300 includes an act 312 for requesting the target to remain on the line when the target answers the target phone number so that the act 306 of calling the callback phone number can be executed.

The process 300 includes an act 314 for timing the call between the target and the subscriber. The act 314 produces a time so as to execute one of two acts. One of the two acts includes terminating the call when the time has reached a desirable limit. The other of the two acts includes billing the time of the call to the subscriber.

### Conclusion

Systems, methods, and structures have been discussed to enhance communications between individuals. While the messaging technology of today has improved the way people communicate, the embodiments of the invention further enhance communications by allowing individuals to be connected whenever possible without having to leave messages back and forth. The embodiments of the invention also use the concept of local point of presence in a digital network such that local exchange carriers may be bypassed.

Although the specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. It is to be understood that the above description is intended to be illustrative, and not restrictive. Combinations of the above embodiments and other embodiments will be apparent to those of skill in the art upon reviewing the above description. The scope of the invention includes any other applications in which the above structures and fabrication methods are used. Accordingly, the scope of the invention should only be determined with reference to the appended claims, along with the full scope of equivalents to which such claims are entitled.

I claim:

1. A method for enhancing communication between individuals, comprising:
setting up a call placement via a piece of software that manages voice data;
calling a target phone number to reach a target;
calling a callback phone number to reach a subscriber; and
connecting a subscriber to the target when the target phone number is answered by the target after which the subscriber answers the callback phone number, and wherein the act of connecting connects the target to the subscriber via a connection that bypasses a local exchange carrier.

2. The method of claim 1, further comprising rescheduling the acts of calling in one of two conditions, wherein one of the two conditions includes that a phone number is busy, and wherein the other of the two conditions includes that the phone number is unanswered.

3. The method of claim 2, wherein setting includes entering the target number of the target into the piece of software, entering the callback number of a subscriber into the piece of software, and entering the time interval by which the act of rescheduling is to occur.

4. The method of claim 1, further comprising requesting the target to remain on the line when the target answers the target phone number so that the act of calling the callback phone number is executed so as to reach the subscriber.

5. The method of claim 1, further comprising timing the call between the target and the subscriber to produce a time so as to execute one of two acts, wherein one of the two acts includes terminating the call when the time has reached a desirable limit, and wherein the other of the two acts includes billing the time of the call to the subscriber.

6. A computer-readable medium having instructions stored thereon for automating a callback, the method comprising:
setting a call placement via a piece of software that manages voice data;
calling a target phone number to reach a target;
calling a callback phone number to reach the subscriber; and
connecting a subscriber to the target when the target phone number is answered by the target after which the callback phone number is answered by the subscriber, and wherein the act of connecting connects the target to the subscriber via a connection that bypasses a local exchange carrier.

7. The method of claim 6, further comprising rescheduling the act of calling the target number in one of two conditions, wherein one of the two conditions includes that the target number is busy, and wherein the other of the two conditions includes that the target number is unanswered.

8. The method of claim 7, wherein setting includes entering the target number of the target into the piece of software, entering the callback number of a subscriber into the piece of software, and entering the time interval by which the act of rescheduling is to occur.

9. The method of claim 6, further comprising requesting the target to remain on the line when the target answers the target phone number so that the act of calling the callback phone number is executed so as to reach the subscriber.

10. The method of claim 6, further comprising timing the call between the target and the subscriber to produce a time so as to execute one of two acts, wherein one of the two acts includes terminating the call when the time has reached a desirable limit, and wherein the other of the two acts includes billing the time of the call to the subscriber.

11. A platform for enhancing communications, comprising:
a subscriber who subscribes to the communication services of the platform;
a target that the subscriber desires to communicate with; and
an engine that executes a call placement that is set up by the subscriber so that the subscriber can be connected to the target if the target answers a target phone number and the subscriber answers the callback phone number, and wherein the connection between the subscriber and the target bypasses a local exchange carrier.

12. The platform of claim 11, further comprising a target node selector that selects a node from which the target phone number is called, wherein the target node selector selects the node based on the area code of the target phone number.

13. The platform of claim 11, further comprising a callback node selector that selects a node from which the callback phone number is called, wherein the callback node selector selects the node based on the area code of the callback phone number.

14. The platform of claim 11, further comprising an inquirer that inquires of the identity of a party answering a phone number, wherein the inquirer determines if the party answering the target phone number is the target, and wherein the inquirer determines if party answering the callback phone number is the subscriber.

15. The platform of claim 14, further comprising a scheduler that reschedules the calling of the callback phone number in one of two conditions, wherein one of the two conditions includes that the party answering the callback phone number is not the subscriber, and wherein the other of the two conditions includes that the callback phone number is unanswered.

16. A system for enhancing communications, comprising:
multiple servers, each server is located in a geographic area to define a node;
a network coupling the multiple servers; and
at least one piece of software in one of the multiple servers that executes a call placement that is placed by a subscriber so that the subscriber can be connected to a target if the target answers a target phone number and the subscriber answers a callback phone number, and wherein the connection automatically occurs so as to eliminate the need for a human operator.

17. The system of claim 16, wherein the system selects a node which is local to the target phone number and another node which is local to the callback phone number such that the connection between the target and the subscriber bypasses local exchange carriers.

18. The system of claim 16, wherein the network includes an asynchronous transfer mode (ATM) network.

19. The system of claim 16, wherein the network includes a satellite network.

20. The system of claim 16, wherein the piece of software includes voice mail.
